(19) United States
(12) Patent Application Publication
(10) Pub. No.: US 2017/0076351 A1
(43) Pub. Date: Mar. 16, 2017

(54) METHOD OF USE OF A UNIQUE PRODUCT IDENTIFICATION CODE

(71) Applicant: Alessandro CAPORUSSO, Piedimonte San Germano (IT)

(72) Inventor: Alessandro CAPORUSSO, Piedimonte San Germano (IT)

(21) Appl. No.: 15/125,496

(22) PCT Filed: Mar. 8, 2015
(86) PCT No.: PCT/IB2015/051688

§ 371 Date: Sep. 12, 2016

(30) Foreign Application Priority Data
Mar. 10, 2014 (IT) RM2014A000110

(51) Int. Cl. G06Q 30/06; G06F 17/30

(52) U.S. Cl. CPC G06Q 30/0627; G06F 17/30879

(57) ABSTRACT

A method of use of a unique product identification code (UPIC) being emitted by a database manager, associated with and applied on a product provides a first UPIC query with a database manager for information on the same product by a user through a software application, an evaluation of a validity of the UPIC by the database manager, a response of the database manager to the user with information related to the product, or if the same product was already purchased, a creation of a provisional connection between the user code and the UPIC queried through the software application. The user provides proof of an alleged purchase of the product by a second UPIC query that is made by the same user at the end of a determined first time period from the first UPIC query, with no other user having queried the same UPIC before the second UPIC query.

### TECHNICAL FIELD

The present invention relates to a method of use of a unique product identification code for each product. In particular, this unique product identification code is issued by a database manager, associated with and applied on a product so that the unique product identification code can be queried by an electronic device. The method is intended in particular to fight against product counterfeiting.

### BACKGROUND ART

The US patent application US2007288267A1 filed on 10 Aug. 2007 by Fou describes a method of use of a universally unique product identification code assigned by a database manager and applied visibly on a product. The method includes the steps of querying a UPIC with a database manager, determining if the unique identification code received from the consumer corresponds to a valid product identification code, determining if the unique product identification code was previously subjected to querying, determining the validity of the unique product identification code on the basis of the fact that such a code has not been previously queried. If the validity is not confirmed, a response of the database manager to the consumer is given as a counterfeit product, and a similar message is sent to others.

The above described method provides that the consumer purchases the product before a procedure to ascertain the authenticity of the product can be started. This constitutes a drawback in many cases. The consumer cannot either query the code before buying the product in order to get general information about the features of the product that the consumer is buying, as well as other pieces of information related to the product itself, or determine whether the product the consumer is buying is genuine or counterfeit.

The international patent application WO 2009/074866 on behalf Hosp, with U.S. priority of 13 Dec. 2007, describes a method of verification of a product bearing an identification code. A database manager in which the identification codes of the products are stored is able to answer the query of the code made by a consumer by checking if the identification code has been interrogated in the database. The database manager may deny an answer about the product if the identification code has already been queried in the past once or, alternatively, a fixed number of times. The database manager is able to assess the likelihood of counterfeiting of the product on the basis of a criterion selected among the type of product, its manufacturer, the number of times in which the identification code has been queried in the past, the statistical infringement data regarding the product, the producer, the value of the product and the geographical origin thereof. It is understandable that Hosp does not provide a precise answer on the originality of the product whose identification code has been queried. Compared with the patent application of Fou, Hosp allows that the identification code can be queried at any time, that is, both before and after the purchase of the product but it does not provide any confirmation to the consumer. It serves only to the database manager to hone his evaluation on the originality of the product itself.

The German patent application DE 10 2006 016830 A1 filed on 11 Oct. 2007 by Springer discloses a method of use of a unique product identification code issued by a database manager defined as state of art in the preamble of claim 1 of this patent application. Springer does not permit to verify that the same unique code has been applied to more than one product and therefore products with the same code have already been purchased by other users.

### DISCLOSURE OF THE INVENTION

One object of the present invention is instead to provide a method that allows any user to get a response about the authenticity of the product as a result of a query of a product identification code occurred both before and after the purchase of the product.

Another object is to check in an automatic and effective way the purchase of a product by a user without the use of controls external to the relationship between manufacturer and user.

A further object of the present invention is to allow an indefinite number of users to query the identification code of the same product in order to get information about it.

Still another object of the invention is to create a two-way communication between a user and a database for any initiative in connection with the product both before and after the purchase.

Also, one object of the invention is to create a communication between users and the manufacturer that is not only focused on the product, but also on the spread of any initiative taken by the manufacturer or by other users in connection with the product both before and after the purchase.

A further object of the invention is to advise users to purchase original products, possibly with incentives such as discounts, prizes, points, and the like, as provided by the manufacturer, as it typically happens for loyal customers.

Another purpose is to inform a manufacturer about the presence on the market of products of his own that are counterfeit.

Still another object is to deter potential counterfeiters from putting on the market counterfeit products.

A further aim is to enable control Authority, in its fight against counterfeiting, to hit counterfeiters immediately upon placing their counterfeit products on the market.

These and other objects are achieved by a method of use of a unique product identification code (UPIC hereinafter) as defined in the main claim and in the dependent claims attached to the present description.

### BRIEF DESCRIPTION OF DRAWINGS

A preferred embodiment of the method of use of a UPIC is shown in the detailed description which follows, with reference to the accompanying drawings in which:

FIG. 1 is a flow diagram of an embodiment of the method of use of a UPIC according to the present invention showing the steps performed by users and a database manager for the execution of the method.

### DESCRIPTION OF AN EMBODIMENT OF THE INVENTION

The method of use of a UPIC, according to the invention, is based on the fact that a database manager that has issued the UPICs, then in turn associated and applied by the manufacturers to their products, can block UPICs that are the same as those applied to products already purchased by other users, according to the criteria set by the database manager and described in the following.

The method of use of a UPIC issued by a database manager and associated to and applied on a product by a manufacturer, so that a correspondence between the UPIC and the product itself is created, allows, as already known, its query by any user in order to receive information and data regarding the product. The term “issued” means, briefly, that UPICs are generated by the database manager and sent to the manufacturers who have signed a supply contract. The term “active” means, briefly, that the manufacturer has created a connection between the single UPIC and the information and data related to the products that the manufacturer himself has entered into the database. The term “query” means, briefly, that a UPIC has been acquired and subsequently queried within the database. The term “user” means, briefly, whoever installed on an electronic device, such as smartphone, tablet and any other device capable of acquiring and transmitting data, the application software provided by the database manager; the application software in turn has been uniquely associated to the user through a user code, which identifies the user with the database manager, and an activation password. The term “database manager” means, briefly, everything that runs a database as a hardware and software computer system.

The query on the basis of a UPIC is a technique known and variously modified according to different choices; consequently there is no need to dwell on these aspects. It is also well known that, following the query of the UPIC, the database manager assesses the validity of the UPIC and gives the user an answer that may include information about both the authenticity of the product and features thereof, and on a previous purchase, if any, of the same product by another user with communication of the clear risk of being faced with a non-authentic product.

A criterion for alleged purchase of the product by a user is established, according to the method of the present invention, by a second query of the UPIC made by the same user after a given first time period from first query thereof, which has created a provisional connection between the UPIC and the user code. This connection becomes permanent if the same user queries again the same UPIC with the same electronic device after said determined first time period, provided that, between the same user's first and second query, a query of the same UPIC is not made by another user. In other words, the UPIC query performed only once by a first user, before a proof of the alleged purchase of the product is associated, allows another query of the same UPIC by a second user. The query made by the second user, which breaks the still provisional connection between the UPIC and the user code of the first user, restarts said first determined time period in favor of the second user; at the end of this period automatically a second query of the same UPIC is requested by the database manager, query that is needed to demonstrate the alleged purchase of the product by the second user to the database manager. The same thing can happen to a third user that inserts himself in the provisional connection of the second user, and so on.

At the moment when a user upon invitation of the database manager provides evidence of the alleged purchase of the product by performing a second query of the same UPIC, the database manager gives the same user exclusive access to information, documents and benefits reserved to the user.

Once provided evidence of the alleged purchase of the product by a user, the database manager gives an answer if any of non authenticity of that product to all the other users who should query the same UPIC.

Optionally, the method according to the present invention establishes that the provisional connection between a user, which is identified by the database manager by the own user code, and the UPIC of the queried product shall break if the second query of the UPIC by the same user is not made within a determined second time period from the end of said determined first time period and the invitation by the database manager.

Advantageously, a purchase transaction of the product affects the said determined first time period; in particular, the true purchase of the product resets the determined first time period. Obviously the determined second time period, within which the second query has to be performed, does not matter any more in this case and is extended to infinity or to a predefined time. For example, if the UPIC was not queried before purchase at a retail shop, the UPIC passes through a checkout counter of a store that is able to give the database manager the proof of true purchase of that product by the user.

From the above, according to the method of the present invention, the step of querying the UPIC by a user with the database manager, provides one of the responses that follow.

At the first query of an active UPIC, with a result of a creation of a provisional connection between UPIC and user code, the database manager sends the user information entered by the manufacturer in this database and taken from a set of data. Active UPIC means a unique code issued by the database manager to a manufacturer who associated the UPIC with a set of product data and applied it to the corresponding product. When the UPIC is active with provisional connection, information taken from a set of data are sent to the user about the product. When the UPIC is active with permanent connection, further information taken from a set of data are sent to the user about the product.

The database manager recognizes that the queried UPIC is a code reserved to the user in order to allow the user to make additional queries of the same UPIC after the user has already provided proof of the alleged purchase of the product and has already had access to information, documents and benefits reserved to the same user. On the other hand, if a user queries a UPIC that does not belong to the database or is not activated, the database manager sends consequential information. In the case of alleged or true purchase of the product by anyone other than the one who makes the query, the database manager interprets the UPIC as blocked, with subsequent sending of information, if any, of non authenticity of the product.

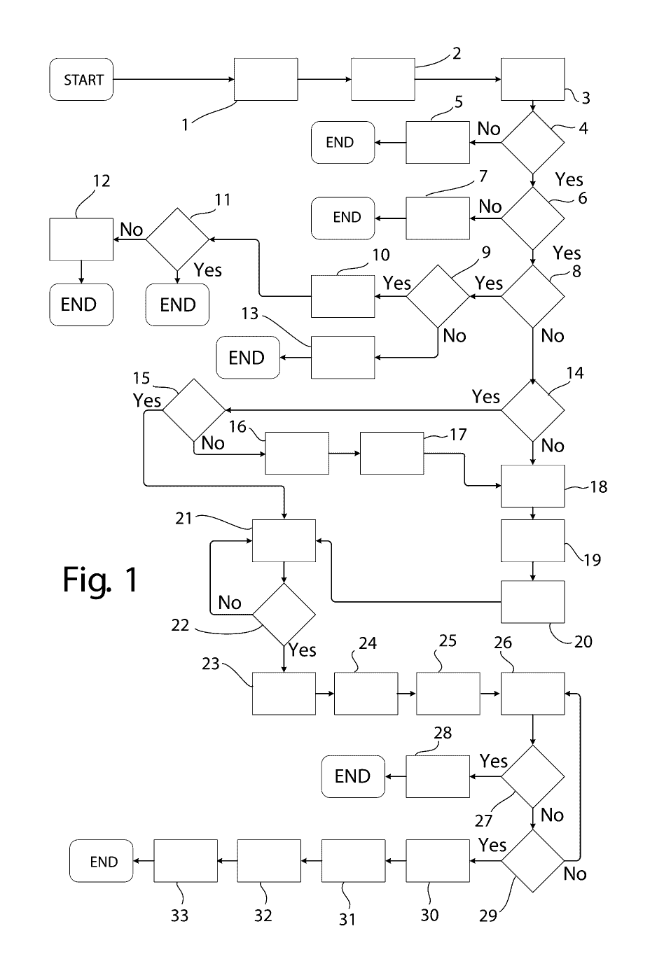

It can happen even that a user wants to return to the seller a product of which the user has already given a proof of alleged or true purchase. When the product is returned, the reserved UPIC is modified by said user in active UPIC, so that the UPIC can be queried by successive users without being sent, before and after the purchase, misleading answers. Consequently, the above user, who had purchased the product, waives the information, documents and benefits reserved to him/her earlier. In the following, to illustrate an embodiment of the method of use of a UPIC according to the present invention, reference is made initially to the flow diagram in FIG. 1.

Procedure starts, and in step 1 a UPIC is acquired by means of an electronic device that can be, for example, a smartphone, a tablet or other device on which a software application, which is provided by a database manager for querying the UPIC itself, is downloaded. Although not shown in the flowchart in FIG. 1, the user is identified by the database manager who supplied him/her with the application software by means of a user code, which could be the cell phone number assigned by the company that provides telephone service, or the IMEI, which uniquely identifies each final mobile. Alternatively any other user code can be chosen that uniquely identifies the user. The user is authorized by the operator of the database to use the application software on its electronic device by means of an activation password. The application software allows the user to detect the UPIC. Passing to step 2, the reading is sent to the database manager.

In step 3, the database manager receives the reading and starts the process of elaboration of the UPIC.

The step 4 is a decision block where the database manager verifies if UPIC belongs or not to its database.

If it does not belong thereto, in step 5 a warning or alert is sent on the user electronic device that warns that the queried UPIC is not in the database. The procedure ends. If the UPIC belongs to the database, the procedure moves to decision block 6, where it is checked whether the UPIC is active or not. If not, the procedure advances to step 7 where pieces of information in this regard are sent with an attention and alert signal, and the procedure ends. In case of affirmative answer, i.e. the UPIC is activated, the procedure moves to decision block 8, where it is checked whether there is already a permanent connection between the queried UPIC and a user. If the answer is affirmative, the procedure moves to decision block 9 where it is checked whether the user who is querying is the same person who created the permanent connection or not.

If so, the procedure goes to step 10, where a set of confidential information is sent to the user relating to benefits for the user; then the procedure moves to decision block 11, where it is checked whether the user has already received points or other advantage.

In case of a negative response in the decision block 11, the procedure comes to step 12, where points are awarded or other advantage, and the procedure ends. In case of an affirmative response, the procedure ends.

If the answer is negative in decision block 9, i.e. the user who is querying is not the same person who created the permanent connection, the procedure comes to step 13 where a warning or alert is sent on the electronic device, that warns that the queried UPIC belongs to a product of which someone else has already given proof of alleged or true purchase: most likely the product in question is not an authentic product and the procedure ends.

If the answer is negative in decision block 8, that is, there is not a permanent connection between a UPIC and a user code, the procedure arrives at decision block 14.

Here, the database manager checks whether there is a provisional connection or not between the UPIC and a user code. An affirmative answer means that a previous user queried the same UPIC, and the database manager started a determined first time period after which a user is enabled to make a second query of the UPIC. In case of an affirmative answer, the procedure passes to decision block 15 where it is checked whether the provisional connection belongs or not to the user who made the query. In case of affirmative answer, the procedure passes to a next waiting step 21. In case of negative answer at the decision block 15, the query of the UPIC by the user in a step 16 breaks the existing provisional connection, and a determined first time period is reset in the next step 17. The procedure arrives at a step 18, where a new provisional connection is created. The same step 18 is reached from the decision block 14, if no provisional connection existed between a UPIC and a previous user.

In step 19, the first determined time period starts, after which a second query of the same UPIC can be made.

In step 20, a series of pieces of information also relating to the authenticity of the product are sent to the electronic device of the user.

In step 21, the database manager is waiting for the first determined time period to pass, after which the user is enabled to make the second query of the UPIC.

In decision block 22 it is checked whether or not this determined first time period has elapsed.

If not, the procedure returns upstream in the waiting step 21.

If the determined first time period has elapsed, the procedure passes to the step 23, where the database manager starts the determined second time period, enables the user to make a second query of the UPIC (step 24), and sends in the same time an invitation to the user electronic device in step 25.

In step 26, the database manager waits for the user to complete the second query. In the control block 27, the database manager determines whether or not all the determined second time period is spent, within which the user has to make the second query in order to create a permanent connection between his/her user code and the UPIC.

If the answer is affirmative, i.e. all the determined second time period is spent without querying, the procedure arrives at a step 28 where the breaking of the provisional connection between user code and UPIC. Then the procedure ends.

In case of negative answer in the control block 27, that is, all the determined second time period is not spent, in a step 29, the database manager checks if the user has performed the second question, or not.

In case of negative answer in the step 29, that is, a second query has not yet been made, the procedure returns to waiting step 26.

In case of affirmative answer, a permanent connection between user code and UPIC is created in a step 30. Then in a step 31 a set of pieces of confidential information is sent to the electronic user device, and in the next step 32 points or other benefit is assigned to the user. In the next step 33 the button to return the purchased product is enabled, with which the user has the right to cancel the purchase with the return of received points or benefits. Then the procedure ends.

In the above description special consideration has been given to the procedure of creating a permanent connection between the UPIC and user code, resulting in a proof of alleged or true product purchase. In this regard, the checkout counter of a retail store gives certainty to the database manager of the true purchase of the product instead of the alleged purchase that is identified when a second query of the same UPIC by a user is made after the determined first time period and before the end of the determined second time period, without passing through the checkout counter.

In consideration of the role played by the checkout counter, the following steps are provided. A software application, hosted in the checkout counter and associated with its user code, sends the just read UPIC to the database manager. The database manager recognizes that it is a privileged user by the user code of the checkout counter. Meanwhile, the database manager automatically performs the function of resetting the determined first time period, and of setting the determined second time period at a time extended to infinity or at a predefined time.

Reverting back to the case of the return of the product, as mentioned above, it is known that the products can be purchased and then for various reasons and in accordance with law, returned to the seller with the formula of economic refund or replacement of the good. If in the meantime a user has created a permanent connection between its user code and the UPIC, once the product is returned, the database manager allows the UPIC to be reactivated, in order to avoid that misleading answers are sent, before and after the purchase, to users who will query the same UPIC after the return of the product by the previous user.

The user, who has previously purchased the product and created a permanent connection between its user code and UPIC, starts a new query and communicates the return of the product to the database manager.

The database manager recognizes that the user code is that one of the user who created a permanent connection with the UPIC.

The database manager records the user code that requires the reactivation process.

The database manager verifies that the UPIC is a reserved code and changes it in active. The database manager certifies that the user is no longer connected permanently to that UPIC because he/she has returned the product and deprives him/her of the information, documents and benefits earlier reserved to him/her. Obviously, the method according to the present invention takes all precautions in order that the UPIC can not be reproduced by a user to provide non-real proof of the alleged purchase of the product. The software application, using known techniques, is able to recognize whether or not the UPIC applied on the product has been reproduced, copied, regenerated, photographed.

It can be understood that the purposes have been achieved that the method according to the present invention aims.

The method allows to make irreproducible the UPICs.

Further, it allows an indefinite number of users to query the UPIC of the same product in order to have information about it, both before and after the purchase of the same.

The method creates a two-way communication of a user with a manufacturer not only about the product but also about any initiative made by the manufacturer either before or after the purchase. Each user is identified through his phone number, or other electronic device, or through other personal identification code, which can also be useful to deter improper use of the application software installed on the phone or other electronic user device. When, instead, an improper use of the method according to the present invention is made by any user, which for example provides proof of alleged purchase without having actually purchased the product, the database manager blocks his/her user code, and also the identifiers of his registered electronic devices, with a result of preventing said user to access additional information about the products that use UPICs, and also deducting all points and advantages previously accumulated by that user. If the user behaves correctly, he/she can enjoy discounts, prizes, points, and the like, also provided by the manufacturer after the query of the UPIC both before and especially after the product purchase.

It also can be understood that manufacturers can be informed of the presence of fake products on the market, improperly marked by their brands, thanks to the queries of the UPICs made by the users or to the reports received from consumers, retailers or Control Authority.

Above all, the same counterfeiters are discouraged from producing and selling on the authorized market fake products using the trademarks of the manufacturers that adopt the method according to the present invention since:

1. The manufacturer shall notify consumers to buy only products that host the UPIC according to the method of the present invention; in case a user should find on the market a product without UPIC, he/she would not perform the purchase and would signal the anomaly because in presence of a clearly false product.

2. When a manufacturer identifies each product and applies on it a UPIC, and communicates it to the consumers, the only chance that the counterfeiter has to introduce the fake products in the authorized market, improperly using the brand, would be to purchase a number n of real products, reproduce and apply on the fakes products n UPICs; the economic loss is obvious and therefore not viable for the counterfeiter. If the counterfeiter instead places on the authorized market a number n of fake products on which he applied only and ever the same UPIC, it is sufficient that a user provides evidence of alleged or true purchase of the product, because the database manager blocks the same UPIC, possibly reporting the non authenticity of these products to all other users who will carry out the query before the purchase of the other counterfeit products.

3. The identification of the counterfeit products can make possible to trace the distribution chain and move promptly to distributors and manufacturers of counterfeit products, giving substantial support to the national and international Control Authorities in combating counterfeiting.

It should be evident that the method according to the present invention is susceptible of modifications and variations that fall within the scope of the invention as defined in the appended claims.

1. A method of use of a unique product identification code (UPIC) being emitted by a database manager, associated with and applied on a product so that the UPIC can be queried by an electronic device, comprising:
a first UPIC query with a database manager for information on the same product by a user through a software application that is downloadable on electronic devices such as smartphones, tablets or other device able to acquire and transmit data and is associated uniquely to the user through a user code, by which the database manager identifies the user, and through an activation password,
an evaluation of a validity of the UPIC by the database manager,
a response of the database manager to the user with information related to the product, or if the same product was already purchased,
a creation of a provisional connection between the user code and the UPIC that is queried through said software application,
characterized in that the user gives a proof of an alleged purchase of the product by a second UPIC query that is made by the same user at the end of a determined first time period from the first UPIC query, with no other user having queried the same UPIC before the second UPIC query.

2. The method according to claim 1, wherein a UPIC query carried out only once by a user before he/she has given a proof of the alleged purchase of the product allows:
another query of the same UPIC by another user that receives information related to the product, and
a restart of said determined first time period required to obtain the proof of the alleged purchase of the product by said another user.

3. The method according to claim 1, wherein said second query of the same UPIC by the same user occurs upon an invitation of the database manager.

4. The method according to claim 1, wherein said second query of the same UPIC by the same user creates a permanent connection between the UPIC and the user code of the same user.

5. The method according to claim 4, wherein said permanent connection gives the same user exclusive access to information, documents, and advantages reserved thereto.

6. The method according to claim 1, wherein a query of the same UPIC after a proof of the alleged purchase of the product is given to the database manager by a user, provides, if any, a response of non-authenticity of the product to all the other users that query the same UPIC.

7. The method according to claim 1, wherein said provisional connection between the user code and the queried UPIC is broken up if the second UPIC query by the same user does not occur within a determined second time period from the end of said determined first time period.

8. The method according to claim 1, wherein said proof of alleged purchase of a product is confirmed as a true proof of purchase of the same product by means of a product purchase transaction, by which said determined first time period is reset to zero.

9. The method according to claim 8, wherein said proof of alleged purchase of a product is confirmed as a true proof of purchase of the same product by means of a product purchase transaction, by which said determined second time period is extended to the infinite.

10. The method according to claim 8, wherein said proof of alleged purchase of a product is confirmed as a true proof of purchase of the same product by means of a product purchase transaction, by which said determined second time period is extended to a preset time.

11. The method according to claim 8, wherein the purchase transaction takes place at a retail store and includes:
the UPIC query with the database manager by a cash register,
the reset to zero of said determined first time period after which the user may repeat the UPIC query and access to information, documents, and advantages reserved thereto, and
the extension of said determined second time period within which the user must repeat the UPIC query to access information, documents and advantages reserved thereto.

12. The method according to claim 1, wherein the UPIC query by the user with the database manager provides one of the following responses:
UPIC not belonging to the data base, case in which consequential information is sent to the user;
active UPIC with a provisional connection, case in which product information from a set of data is sent to the user;
active UPIC with a permanent connection, after the user has made a second UPIC query at the end of said determined first time period, case in which further product information from a set of data is sent to the user;
reserved UPIC, in case the user makes further queries of the same UPIC on the product after having already given proof of alleged or true purchase of the product and having already accessed information, documents, and advantages reserved thereto;
not-active UPIC in case of a not activated UPIC, with consequential information being sent;
blocked UPIC, in case of alleged or true purchase of the product by a user different from the user who queries, with non authentic product information being sent subsequently, if any.

13. The method according to claim 12, wherein the UPIC is changed by the user who has given proof of alleged or true purchase of the product into active UPIC in case the product is returned to the retail store, with a consequence of a renounce to information, documents and advantages reserved thereto.

14. The method according to claim 9, wherein the purchase transaction takes place at a retail store and includes:
the UPIC query with the database manager by a cash register,
the reset to zero of said determined first time period after which the user may repeat the UPIC query and access to information, documents, and advantages reserved thereto, and
the extension of said determined second time period within which the user must repeat the UPIC query to access information, documents and advantages reserved thereto.

15. The method according to claim 10, wherein the purchase transaction takes place at a retail store and includes:
the UPIC query with the database manager by a cash register,
the reset to zero of said determined first time period after which the user may repeat the UPIC query and access to information, documents, and advantages reserved thereto, and
the extension of said determined second time period within which the user must repeat the UPIC query to access information, documents and advantages reserved thereto.

16. The method according to claim 2, wherein the UPIC query by the user with the database manager provides one of the following responses:
UPIC not belonging to the data base, case in which consequential information is sent to the user;
active UPIC with a provisional connection, case in which product information from a set of data is sent to the user;
active UPIC with a permanent connection, after the user has made a second UPIC query at the end of said determined first time period, case in which further product information from a set of data is sent to the user;
reserved UPIC, in case the user makes further queries of the same UPIC on the product after having already given proof of alleged or true purchase of the product and having already accessed information, documents, and advantages reserved thereto;
not-active UPIC in case of a not activated UPIC, with consequential information being sent;
blocked UPIC, in case of alleged or true purchase of the product by a user different from the user who queries, with non authentic product information being sent subsequently, if any.

17. The method according to claim 3, wherein the UPIC query by the user with the database manager provides one of the following responses:
UPIC not belonging to the data base, case in which consequential information is sent to the user;
active UPIC with a provisional connection, case in which product information from a set of data is sent to the user;
active UPIC with a permanent connection, after the user has made a second UPIC query at the end of said determined first time period, case in which further product information from a set of data is sent to the user;
reserved UPIC, in case the user makes further queries of the same UPIC on the product after having already given proof of alleged or true purchase of the product and having already accessed information, documents, and advantages reserved thereto;
not-active UPIC in case of a not activated UPIC, with consequential information being sent;
blocked UPIC, in case of alleged or true purchase of the product by a user different from the user who queries, with non authentic product information being sent subsequently, if any.

18. The method according to claim 4, wherein the UPIC query by the user with the database manager provides one of the following responses:
UPIC not belonging to the data base, case in which consequential information is sent to the user;
active UPIC with a provisional connection, case in which product information from a set of data is sent to the user;
active UPIC with a permanent connection, after the user has made a second UPIC query at the end of said determined first time period, case in which further product information from a set of data is sent to the user;
reserved UPIC, in case the user makes further queries of the same UPIC on the product after having already given proof of alleged or true purchase of the product and having already accessed information, documents, and advantages reserved thereto;
not-active UPIC in case of a not activated UPIC, with consequential information being sent;
blocked UPIC, in case of alleged or true purchase of the product by a user different from the user who queries, with non authentic product information being sent subsequently, if any.

19. The method according to claim 5, wherein the UPIC query by the user with the database manager provides one of the following responses:
UPIC not belonging to the data base, case in which consequential information is sent to the user;
active UPIC with a provisional connection, case in which product information from a set of data is sent to the user;
active UPIC with a permanent connection, after the user has made a second UPIC query at the end of said determined first time period, case in which further product information from a set of data is sent to the user;
reserved UPIC, in case the user makes further queries of the same UPIC on the product after having already given proof of alleged or true purchase of the product and having already accessed information, documents, and advantages reserved thereto;
not-active UPIC in case of a not activated UPIC, with consequential information being sent;
blocked UPIC, in case of alleged or true purchase of the product by a user different from the user who queries, with non authentic product information being sent subsequently, if any.

20. The method according to claim 6, wherein the UPIC query by the user with the database manager provides one of the following responses:
UPIC not belonging to the data base, case in which consequential information is sent to the user;
active UPIC with a provisional connection, case in which product information from a set of data is sent to the user;
active UPIC with a permanent connection, after the user has made a second UPIC query at the end of said determined first time period, case in which further product information from a set of data is sent to the user;
reserved UPIC, in case the user makes further queries of the same UPIC on the product after having already given proof of alleged or true purchase of the product and having already accessed information, documents, and advantages reserved thereto;
not-active UPIC in case of a not activated UPIC, with consequential information being sent;
blocked UPIC, in case of alleged or true purchase of the product by a user different from the user who queries, with non authentic product information being sent subsequently, if any.
